(19) United States
(12) Patent Application Publication
(10) Pub. No.: US 2026/0307584 A1
(43) Pub. Date: Oct. 8, 2026

(54) Head Rest for a Vehicle Seat with a Light

(71) Applicant: Illinois Tool Works Inc., Glenview, IL (US)

(72) Inventor: Jordi Bielsa Bonet, Barcelona (ES)

(21) Appl. No.: 19/573,876

(22) Filed: Mar. 20, 2026

(30) Foreign Application Priority Data
Apr. 3, 2025 (DE) 10 2025 113 027.2

(51) Int. Cl. B60Q 3/233; B60N 2/812; B60N 2/879; B60Q 3/62

(52) U.S. Cl. CPC B60Q 3/233; B60N 2/812; B60N 2/879; B60Q 3/62

(57) ABSTRACT

A headrest assembly for a vehicle seat is provided. The headrest assembly includes at least two headrest rods extending substantially parallel to one another and configured to support a head cushion. A headrest guide assembly is configured to receive the headrest rods within a seatback such that the headrest rods are adjustable along a longitudinal direction between at least a first position and a second position. The headrest guide assembly includes at least one lighting device configured to illuminate at least a portion of one or more of the headrest rods, the illumination being provided directly or indirectly and selectively as needed.

### RELATED APPLICATION

The present application claims the benefit of German Patent Application No. DE 10 2025 113 027.2, filed Apr. 3, 2025, titled “Head Rest for a Vehicle Seat with a Light,” the contents of which are hereby incorporated by reference.

### BACKGROUND

Headrests are an important part of the passive safety system in vehicles. Their primary function is to reduce the forces acting on the cervical spine of the occupants in case of sudden changes in vehicle movement, such as those that occur in a traffic accident, and thus reduce the risk of injuries, such as whiplash. In addition to improving safety, headrests also serve to increase ride comfort by providing support to the head and neck. In order to optimally perform these functions, headrests are typically height adjustable so that they can be individually adjusted to the height of the respective vehicle occupants.

Typically, such headrests have two headrest rods for this purpose, which are slidably mounted in corresponding receptacles, the so-called headrest guides in the backrest of the vehicle seat. A mechanical lock with locking points on the rods ensures that the headrest is securely held in the selected position.

Parallel to these functional aspects, the vehicle interior has developed into an important differentiation feature for automobile manufacturers in recent years. The interior design, the materials used, and the ambient lighting are increasingly used to create a specific atmosphere that ranges from sporty-purist to luxuriously comfortable, and thus influence the attention and purchase decisions of consumers. Ambient lighting is used in a targeted manner to increase the perceived sense of value, safety, and space. Known solutions include illumination of decorative trim in the dash and door panels, illumination of speaker grilles, air vents, or even the integration of logos into the seating surfaces or starry sky effects into the headliner.

However, the known prior art has disadvantages. The existing solutions for ambient lighting are limited to static, purely decorative surfaces or singular functional components. An integration of lighting solutions in movable, safety-relevant, and structural components, such as the headrest assembly, has not yet taken place. The headrest rods and their guides are considered to be purely functional, technical needs that play no role in the design of the interior.

This is a missed opportunity to integrate another prominent seat element into the holistic lighting concept of the vehicle, thereby creating new, unique design opportunities. Such integration is technically challenging because the lighting fixture must be robust, durable, inexpensive, and securely integrated into the mechanical guide and adjustment function of the headrest without compromising it.

### SUMMARY OF THE DISCLOSURE

The present disclosure relates generally to a headrest, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a schematic illustration of a headrest according to the present disclosure mounted on a vehicle seat, as well as an enlarged view of a guide sleeve body.

FIG. 2 illustrates schematic views of a first embodiment of a guide sleeve body according to the present disclosure with a lighting device comprising a light diffuser.

FIG. 3 illustrates schematic views of a second embodiment of a guide sleeve body according to the present disclosure with a lighting device comprising an annular light source support.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to adjustable headrest assemblies for a vehicle seat, in particular a motor vehicle seat. More specifically, the disclosure relates to a headrest for a vehicle seat having a special headrest guide assembly with an integrated lighting device, as well as such a headrest guide assembly itself and a method for illuminating a vehicle interior using that assembly.

The object of the present disclosure is thus to specify a headrest assembly for a vehicle that overcomes the drawbacks of the prior art. In particular, a solution is to be created that enables novel and aesthetically appealing ambient lighting by incorporating a purely functional component into the design concept of the vehicle interior.

In particular, the headrest is designed to maintain its safety-relevant and ergonomic functions without restriction, to be simple and cost-effective to manufacture and install, while at the same time significantly increasing the perceived value and the ambiance of the vehicle.

Accordingly, the disclosure relates in particular to a headrest for a vehicle seat, the headrest comprising: two at least substantially parallel headrest rods or headrest rod portions, on which a head cushion of the headrest is disposed or arrangeable; and a headrest guide assembly via which the headrest rods or headrest rod portions are received, or receivable, on, and in particular in, a seat back of the vehicle seat such that the headrest rods or headrest rod portions, with the head cushion of the headrest optionally arranged on the headrest rods or headrest rod portions, are adjustable, and in particular slidable, in a longitudinal extension direction of the headrest rods or the headrest rod portions relative to the headrest guide assembly between a first position and at least one second position, wherein at least one lighting device is associated with the headrest guide assembly or in that the headrest guide assembly comprises at least one lighting device which is configured to illuminate at least one of the two headrest rods or headrest rod portions, and in particular both headrest rods or headrest rod portions, in particular as needed, at least partially or regionally, at least indirectly.

The core of the disclosure is to use the headrest guide assembly itself, a purely mechanical and mostly invisible component, as a support for a lighting device.

By emitting light from the base of the headrest rods and illuminating them, a completely new visual effect is achieved. The headrest rods, usually chromed or painted metal bars, become luminous accents that appear to grow out of the seat. This provides a psychological appreciation and a clear luxury feature as required by customers and design studies, and enables a strong emotional connection to the vehicle.

This integration provides significant advantages over the prior art. Rather than illuminate another surface, a dynamic structural element is illuminated. The lighting is subtle and indirect, which avoids glare effects and creates a high-quality, comfortable atmosphere. The technical effect is that a functional component is given an aesthetic dual function without compromising its primary function-the safe and stable guidance of the headrest. This allows automobile manufacturers to stand out from the competition through a unique and innovative design feature that is deeply integrated into the vehicle architecture.

The solution according to the disclosure is also flexibly configurable. Depending on the design of the lighting device and the surface condition of the headrest rods, the light may appear soft and diffuse or sharp and accentuated. The color and intensity of the lighting can be controlled via the central control system of the vehicle and synchronized with the rest of the ambient lighting. For example, the lighting may be adjusted to the selected driving mode (e.g., red for “sport”, blue for “eco”), or may pulse as the doors are opened to welcome the driver.

The disclosure further relates to a headrest guide assembly for a headrest of a vehicle seat, wherein the headrest comprises two headrest rods, and the headrest guide assembly is configured to slidably receive the headrest rods, wherein the headrest guide assembly comprises a lighting device configured to illuminate at least one of the headrest rods at least indirectly. The disclosure describes a headrest guide assembly that can be commercialized as a standalone, tradable product.

This provides a critical benefit to the automotive industry supply chain. Seat manufacturers or suppliers can obtain this intelligent, illuminated guide unit as a pre-assembled module and integrate it into their existing seat structures without having to carry out the complex development of the integration of optics, electronics, and mechanics themselves. This significantly lowers the development costs and the complexity for the seat manufacturer.

Technically, this approach enables high process reliability and quality. The lighting unit, including light source, light guide, and control electronics, may be manufactured, tested, and qualified as one unit.

This ensures that the light output, the color temperature, and the service life are consistent throughout production. For the automotive manufacturer, this means simplified assembly and higher reliability of the final product, as a critical interface between mechanics and electronics is shifted into a single, validated component.

As an alternative configuration, such a modular guide unit could be provided with standardized electrical and mechanical interfaces.

This would allow the same base unit to be used in different vehicle models or even different manufacturers, resulting in economies of scale and further cost reduction. The specific light color or control could then be defined in software by the respective vehicle, meaning maximum flexibility with minimum hardware variance.

Finally, the disclosure relates to a method of lighting a vehicle interior, comprising the steps of: providing a headrest of the type according to the disclosure described above; activating the lighting means disposed in the headrest guide assembly to emit light; and directing the light from the lighting device to illuminate at least one area of at least one of the headrest rods visible outside the headrest guide assembly.

This disclosed method relates to application of the device, namely the active generation of a light effect in the interior. The technical effect of the method lies in the targeted illumination of the visible part of the headrest rods. The step of “conducting the light” ensures that the light energy is used efficiently and is only used where the aesthetic effect is desired. This avoids scattered light inside the seat structure and maximizes visible brightness with minimal energy consumption. This targeted use of light is a notable aspect of the high-quality impression that the disclosure imparts.

The method also allows dynamic interaction with the user and the vehicle state.

The step of “activating” may be coupled to various events, such as unlocking the vehicle, selecting a driver profile, or even warning messages from the vehicle. For example, if emergency braking occurs, the lighting could illuminate red to alert subsequent occupants. Such contemplated developments show that the method goes beyond purely static ambient lighting and has the potential for a functional, safety-enhancing application.

According to a preferred embodiment, it may be provided that the at least one lighting device is configured to illuminate at least one region of at least one of the two headrest rods or headrest rod portions, which is not received by the headrest guide assembly, in particular as needed, at least partially or regionally, at least indirectly.

This construction ensures that the light energy is used purposefully and efficiently to achieve the desired aesthetic effect. Only the visible portion of the rod projecting from the guide is illuminated to prevent light from being lost inside the seat back. This leads to higher brightness with the same energy input and avoids undesirable reflections or light shining through the seat cover.

In an alternative development, it can be provided that the headrest further comprises a lock, in particular manually actuatable, which can be moved between a first state (locked state) and a second state (unlocked state).

The integration of a lock is notable for the safe use of the headrest as it fixes the position of the headrest and prevents unintended adjustment.

This embodiment ensures that the disclosure meets the basic safety requirements for a modern headrest. Manual actuation ensures intuitive and easy handling for the user.

According to realizations of the disclosure, it is provided that the at least one lighting device is configured to illuminate at least one region of the in particular manually actuatable lock, in particular as needed, at least partially or regionally, at least indirectly.

Illumination of the locking mechanism provides a significant benefit to usability, especially in low light conditions. The user can easily find and operate the adjustment button or lever, which promotes correct and secure adjustment of the headrest.

This not only contributes to comfort, but also indirectly to safety, as a correctly adjusted headrest performs its protective function best. In addition, the illumination of a control element is advantageous.

According to a preferred embodiment, it can be provided that the at least one lighting device comprises a light source support (e.g., a board with an LED) and a light diffuser coupled thereto, which directs light onto the headrest rod.

This two-piece design provides high flexibility in design and excellent light quality. The light diffuser, also called a light guide, can be shaped to receive the spotlight of the LED and convert it into a soft, homogeneous, and uniform surface illumination of the headrest rod, avoiding unsightly “hotspots”. In addition, the light diffuser protects the sensitive light source from mechanical stress, dust, and moisture.

In an alternative development, it can be provided that the light diffuser comprises a body formed from transparent or translucent material, in particular a hollow cylinder, through which the headrest rod is guided.

The design as a hollow cylinder is a particularly elegant and technically simple solution for annularly enclosing the headrest rod. This allows for very uniform 360-degree illumination of the rod and compact integration into the guide sleeve. The use of transparent or translucent plastic also enables inexpensive manufacture in the injection molding process.

According to embodiments of the disclosure, it is provided that the at least one lighting device comprises an annular light source support with a plurality of LEDs through which one of the headrest rods is guided.

This alternative design allows very high light intensity and direct illumination of the rod without the detour via a light diffuser. The arrangement of several LEDs on a ring provides a redundant and uniform light distribution, even if a single LED should fail. This construction is particularly suitable for designs that are intended to produce a bright, brilliant light effect.

According to a preferred embodiment, it can be provided that the headrest guide assembly comprises first and second guide sleeve bodies for receiving each of the headrest rods.

This design corresponds to the established standard for headrest guides and ensures stable and secure guidance of the headrest. It forms the mechanical base into which the lighting device according to the disclosure can be elegantly integrated. The partitioning into two separate guide bodies allows symmetrical illumination of both rods.

In an alternative development, it can be provided that the guide sleeve bodies are received or receivable in corresponding receptacles in the seat back of the vehicle seat.

This embodiment describes the standardized interface to the vehicle seat and ensures the compatibility of the arrangement according to the disclosure with existing seat structures. It allows for easy and fast assembly of the entire headrest guide assembly during seat manufacturing. This is a key benefit for smooth integration into mass production.

According to embodiments of the disclosure, it is provided that the headrest guide assembly has a tolerance compensation for equalizing tolerance variations between the distances of the two headrest rods.

This technical characteristic is of high practical value as it compensates for manufacturing-related inaccuracies in the seat structure. The tolerance compensation ensures that the headrest can always be adjusted easily and without jamming, which significantly increases the perceived quality and ease of use. This also prevents stress and premature wear of the guide components.

According to a preferred embodiment, it may be provided that the body of the light diffuser formed from transparent or translucent material is disposed in the first or second guide sleeve body.

This is the most compact and robust form of integration as the light diffuser is cast or inserted directly into the housing of the guide sleeve. This optimally protects the light diffuser from external influences and reduces the number of individual parts, which simplifies assembly and reduces costs. This integral design leads to a particularly clean and high-quality overall appearance.

In an alternative development, it may be provided that the headrest guide assembly comprises an acoustic insulation device for reducing noises between the headrest bars and the headrest guide assembly.

The acoustic insulation is a critical feature for a premium driving experience, as it prevents unwanted rattling or squeaking noises while driving or when adjusting the headrest. This significantly contributes to the reduction of noise, vibration, and harshness (NVH) and increases the comfort and perceived quality of the entire vehicle. The lack of noise is a clear sign of a high-quality mechanical design.

It should therefore be noted that the disclosure relates to a novel headrest assembly for vehicle seats in which an illumination device is directly integrated into the headrest guide assembly. Instead of illuminating merely decorative surfaces as is customary in the prior art, the disclosure uses the guide sleeves mounted to the seat back to illuminate the headrest bars themselves. This creates a unique visual effect in which the rods appear as floating light accents.

The decisive advantage lies in turning a previously purely functional and often overlooked component into a central element of the interior design, thus significantly increasing the perceived value and the ambiance of the vehicle.

For the technical implementation of this effect, the disclosure proposes two primary embodiments. One variant uses a so-called light diffuser, which is configured as a transparent or translucent hollow cylinder and encloses the head restraint rod. A laterally arranged light source, typically an LED, feeds light into this body, which then guides it evenly onto the surface of the rod.

This leads to particularly soft, homogeneous, and indirect illumination.

Alternatively, an annular light source support having a plurality of LEDs may be positioned directly around the headrest rod, allowing for more intense and brilliant direct lighting.

Both solutions are designed to integrate compactly and robustly into existing mechanics.

Beyond the pure aesthetics, the disclosure also improves usability and comfort. The headrest assembly retains its full functionality, including height adjustability and a manually actuatable lock for secure locking.

A particular advantage arises when the lighting device is designed to illuminate not only the rods but also the area of the locking mechanism. This makes it easier for the user to find and operate the adjustment button in the dark, making the correct and secure adjustment of the headrest more intuitive and comfortable.

From a manufacturing and qualitative point of view, the disclosure also offers significant advantages. The headrest guide assembly may be designed as a standalone, pre-assembled, and tested module, simplifying the supply chain for vehicle manufacturers and ensuring consistent high quality.

Features such as integrated tolerance compensation compensate for manufacturing-related deviations in the seat structure and ensure smooth and jam-free adjustment at all times. In addition, acoustic insulation may be provided to prevent rattling or frictional noises, which significantly contributes to the quiet and luxurious overall impression of the vehicle interior.

In summary, the disclosure creates a multi-functional component that combines a safety-relevant guiding mechanism with sophisticated ambient lighting. Through connection to the vehicle electronics, the lighting can be dynamically controlled and can be adapted to driver profiles, driving modes, or welcome scenarios.

The disclosure is not only limited to the entire headrest, but also protects the innovative guide unit as a separate component as well as the method for generating the unique light effect. This is a holistic approach that takes into account both design and user experience as well as practical industrial implementation.

Before discussing in greater detail the exemplary embodiment shown in the drawings, the disclosure is to be briefly summarized again.

In particular, the disclosure relates to a headrest assembly for a vehicle seat in which an illumination system is directly integrated into the headrest guide assembly, the component mounted in the backrest and receiving and guiding the headrest rods. The main purpose of this lighting system is to provide ambient lighting by lighting the headrest rods themselves and/or the components of the guide assembly. This creates a novel aesthetic effect by turning a typically expedient and hidden component into a decorative element of the interior.

Ambient lighting is increasingly being used in modern vehicle interiors to enhance the impression of luxury, value, and safety (e.g., by lighting controls). However, existing solutions focus on static surfaces such as door panels, dashboards, speaker grills, or vents. There is a lack of solutions that integrate lighting into functional, adjustable components such as the headrest bracket.

The disclosure solves this problem by a method that allows:
Integration of sophisticated lighting into the headrest assembly in an inexpensive and structurally sound manner.
Creating a unique and dynamic visual effect by lighting the adjustable headrest rods.
Improving the premium feel and atmosphere in the interior without fundamentally revising the core mechanism of the headrest.
Improving usability by illuminating the adjustment or locking mechanism of the headrest.

The headrest system includes a headrest pad/cushion, at least two substantially parallel headrest rods attached to the pad, and a headrest guide assembly configured for mounting in a vehicle seat backrest. This guide slidably accommodates the headrest rods for vertical adjustment.

An illuminating device is structurally integrated into or disposed within the headrest guide. This illuminating device is configured to radiate light to illuminate at least a portion of at least one of the headrest rods, particularly the portion visible above the guide.

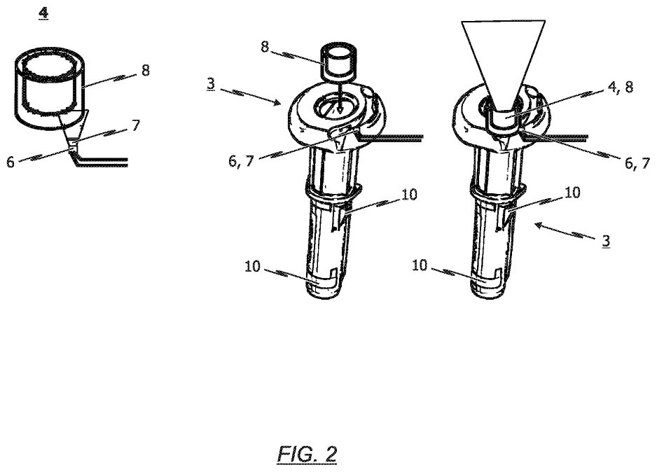

With reference to FIG. 2, the lighting device comprises a light source (e.g., an LED on a printed circuit board) and a light diffuser. The light diffuser is a body of a transparent or translucent material (e.g., injection-molded polymer).

The distributor is shaped as a hollow cylinder or sleeve through which a headrest rod passes. The light source radiates light into the distributor, which then directs and emits the light towards the headrest rod, thereby creating an indirect lighting effect.

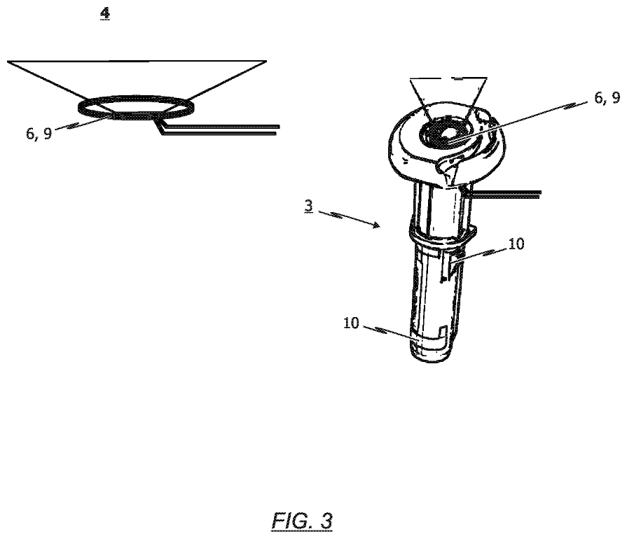

With reference to FIG. 3, the illuminating device comprises an annular light support (e.g., an annular printed circuit board). Several LEDs are mounted on this ring. A headrest rod passes through the middle of the ring and the LEDs illuminate the rod directly.

Generally, the illuminating device is configured to specifically illuminate the portion of the headrest rods that is not accommodated within the guide assembly.

The disclosure lies in particular in the integration of the light source into the functional support and guide structure of an adjustable component. The prior art illuminates static panel parts, single-function components (ventilation openings), or decorative logos. This disclosure illuminates the actual structural supports of the headrest by embedding the lighting system in the guide mechanism itself, which represents a more complex and novel technical integration.

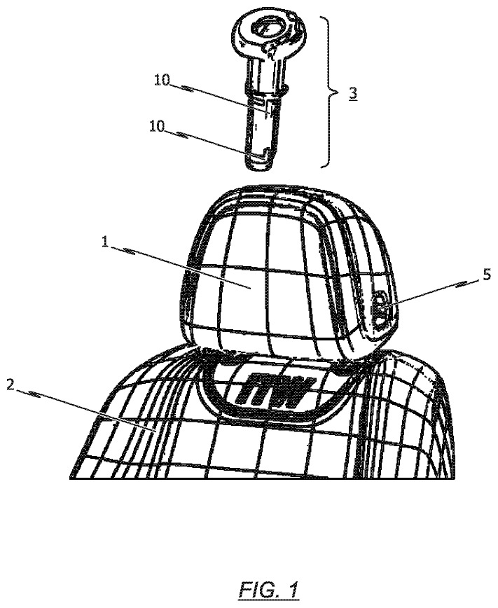

In detail, FIG. 1 shows a schematic representation of a headrest 1 according to the disclosure mounted on a vehicle seat 2.

The headrest 1 comprises a head cushion (not explicitly numbered) connected to the backrest of the vehicle seat 2 via two headrest rods. The connection and guidance of the headrest rods is effected via a headrest guide assembly, which in this embodiment comprises two separate guide sleeve bodies 3, one of which is shown in an enlarged view. Each guide sleeve body 3 is configured to receive one of the headrest rods and enable vertical adjustment thereof.

A lock 5 is provided on the guide sleeve body 3, for example in the form of a push-button, with which the position of the headrest 1 can be locked and released.

Furthermore, the guide sleeve body 3 comprises elements for tolerance compensation 10, which compensate for production-related distance fluctuations between the two headrest rods and thus ensure a smooth and always jam-free adjustment.

FIG. 2 shows schematic views of a first embodiment of a guide sleeve body 3 according to the disclosure with an integrated lighting device 4.

In this embodiment, the lighting device 4 comprises a combination of a light source support 6 with a light source 7 and a separate light diffuser 8. The light source support 6 is embodied as a small, printed circuit board, for example, on which the light source 7, preferably an energy-efficient LED, is disposed. The light diffuser 8 is manufactured as a body made of a transparent or translucent material, for example a plastic made in an injection-molding process, and comprises a central passageway for the headrest rod.

The light emitted by the light source 7 is coupled to the light diffuser 8, guided within it, and exits again at a defined exit surface to indirectly illuminate the headrest rod.

The right-hand illustration in FIG. 2 illustrates how the light exiting the guide sleeve body 3 forms a light beam that illuminates the portion of the headrest rod projecting from the guide and thus generates a suspended, homogeneous light effect.

FIG. 3 shows schematic views of a second, alternative embodiment of a guide sleeve body 3 according to the present disclosure.

In this variant of the lighting device 4, a separate light diffuser is omitted. Instead, an annular light source support 9 is used, which is embodied as an annular printed circuit board, for example, and carries a plurality of light sources (such as LEDs). This light source support 6, 9 is positioned around the passageway for the headrest rod such that the light sources illuminate the rod directly and from multiple directions.

This design allows for particularly intensive and brilliant lighting of the headrest rod. As in the first embodiment, the entire lighting device 4 is compactly integrated into the guide sleeve body 3, which also has elements 10 for tolerance compensation to ensure flawless mechanical function.

While the present method and/or system has been described with reference to certain aspects, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular aspects disclosed. Instead, the present method and/or system will include all aspects falling within the scope of the appended claims, both literally and under the doctrine of equivalents.

### LIST OF REFERENCE NUMERALS

1 Headrest
2 Vehicle Seat
3 Guide Sleeve Body
4 Lighting Device
5 Lock
6 Light Source Support
7 Light Source
8 Light Diffuser
9 Annular Light Source Support
10 Tolerance Compensation

What is claimed is:

1. A headrest (1) for a vehicle seat (2), wherein the headrest (1) comprises the following:
two headrest rods or headrest rod portions that extend at least substantially parallel and on which a head cushion of the headrest (1) is or can be arranged; and
a headrest guide assembly via which the headrest rods or headrest rod portions are or can be received on a seatback of the vehicle seat (2) in such a way that the headrest rods or headrest rod portions with the head cushion of the headrest (1) arranged on the headrest rods or headrest rod portions can be adjusted in a longitudinal direction of extension of the headrest rods or headrest rod portions in relation to the headrest guide assembly between a first position and at least one second position,
wherein that at least one lighting device (4) is associated with the headrest guide assembly or that the headrest guide assembly comprises at least one lighting device (4), which is configured to illuminate at least one of the two headrest rods or headrest rod portions.

2. The headrest (1) according to claim 1, wherein the at least one lighting device (4) is configured to illuminate at least one area of at least one of the two headrest rods or headrest rod portions that is not received by the headrest guide assembly.

3. The headrest (1) according to claim 1, wherein the headrest (1) further comprises:
an actuatable lock, which can be transferred between a first state and a second state, wherein the first state of the lock (5) corresponds to a locked state in which an adjustability of the headrest rods or headrest rod portions in relation to the headrest guide assembly is blocked, and wherein the second state of the lock (5) corresponds to an unlocked state in which an adjustability of the headrest rods or headrest rod portions in relation to the headrest guide assembly is possible.

4. The headrest (1) according to claim 3, wherein the at least one lighting device (4) is configured to illuminate at least one region of the manually actuatable lock (5).

5. The headrest (1) according to claim 1, wherein the at least one lighting device (4) comprises the following:
a light source support (6, 9) having at least one light source (7) in the form of an LED; and
a light diffuser (8) that is optically coupled or couplable to the at least one light source (7) via at least one light entry region, wherein the light diffuser comprises at least one light exit region via which light is decouplable to direct lighting or illumination of a region of the at least one headrest rod or the at least one headrest rod portion.

6. The headrest (1) according to claim 5,
wherein the light diffuser (8) comprises a body formed at least regionally, which comprises a particularly material-free passageway, through which the headrest rod or the headrest rod portion is guided, wherein the body of the light diffuser (8) formed at least regionally from a transparent or translucent material.

7. The headrest (1) according to claim 1, wherein the at least one lighting device (4) comprises the following:
an annular light source support (9) with at least one light source (7), wherein one of the two headrest rods or the headrest rod portions is guided through the annular light source support (9).

8. The headrest (1) according to claim 1,
wherein the headrest guide assembly comprises a first guide sleeve body (3), which is associated with a first headrest rod or a first headrest rod portion of the two headrest rods or two headrest rod portions and in which the first headrest rod or the first headrest rod portion is or can be at least partially or regionally received; and
wherein the headrest guide assembly comprises a second guide sleeve body (3), which is associated with a second headrest rod or second headrest rod portion of the two headrest rods or two headrest rod portions and in which the second headrest rod or second headrest rod portion is or can be at least partially or regionally received.

9. The headrest (1) according to claim 8, wherein the first guide sleeve body (3) is received or receivable at least partially or regionally in a first receptacle embodied in or on the seat back of the vehicle seat (2), and wherein the second guide sleeve body (3) is received or receivable at least partially or regionally in a second receptacle embodied in or on the seat back of the vehicle seat (2).

10. The headrest (1) according to claim 1, wherein the headrest guide assembly comprises a tolerance compensation (10) for compensating for any tolerance fluctuations in the distances between the two headrest rods or headrest rod portions extending substantially parallel.

11. A headrest (1) according to claim 6, wherein the body of the light diffuser (8), formed at least regionally from a transparent or translucent material, is arranged or formed at least regionally in the first or second guide sleeve body (3) of the headrest guide assembly.

12. A headrest guide assembly for a headrest (1) of a vehicle seat (2), the headrest (1) having two headrest rods, the headrest guide assembly being configured to slidably receive the headrest rods,
wherein the headrest guide assembly comprises a lighting device (4), which is configured to illuminate at least one of the headrest rods at least indirectly.

13. The headrest guide assembly according to claim 12,
wherein the lighting device (4) comprises a light source support (6, 9) with a light source (7) and a light diffuser (8), wherein the light diffuser (8) comprises a material-free passage through which one of the headrest rods is guided.

14. The headrest guide assembly according to claim 12,
wherein the lighting device (4) comprises an annular light source support (9) with at least one light source (7), wherein one of the headrest rods is guided through the annular light source support (9).

15. The headrest guide assembly according to claim 12, further comprising a first and a second guide sleeve body (3) for receiving each of the headrest rods, wherein the lighting device (4) is integrated into at least one of the guide sleeve bodies (3).

16. The headrest guide assembly according to claim 12, further comprising a tolerance compensation (10) for compensating for tolerance variations between the distances of the two headrest rods.

17. The headrest guide assembly according to claim 12, further comprising an acoustic insulation device for reducing noise between the headrest rods and the headrest guide assembly.

18. A method of lighting a vehicle interior, comprising the steps of:
providing a headrest (1) according to claim 1;
activating the lighting device (4) disposed in the headrest guide assembly to emit light; and
directing the light from the lighting device (4) to illuminate at least one region of at least one of the headrest rods that is visible outside the headrest guide assembly.

19. A headrest guide assembly for a vehicle seat, the vehicle seat including a seatback and a headrest having two headrest rods extending at least substantially parallel to one another, the headrest guide assembly comprising:
one or more guide sleeve bodies configured to be coupled to the seatback and to slidably receive the two headrest rods such that the headrest is adjustable relative to the seatback along a longitudinal direction of the headrest rods between at least a first position and a second position; and
at least one lighting device associated with the one or more guide sleeve bodies,
wherein the at least one lighting device is configured to emit light to illuminate at least a portion of at least one of the headrest rods.

20. The headrest guide assembly of claim 19, wherein the at least one lighting device comprises a light source support having at least one light source and a light diffuser optically coupled to the at least one light source, the light diffuser defining a passage through which one of the headrest rods extends and including at least one light exit region configured to direct light toward the headrest rod.
